(19) United States
(12) Patent Application Publication
(10) Pub. No.: US 2016/0110666 A1
(43) Pub. Date: Apr. 21, 2016

(54) DISTRIBUTED WORKER-SOURCED PROCESS ENGINEERING

(71) Applicant: HEWLETT-PACKARD DEVELOPMENT COMPANY, L.P., Houston, TX (US)

(72) Inventors: Maher Rahmouni, Bristol (GB); Hamid Reza Motahari Nezhad, Los Altos, CA (US); Claudio Bartolini, Palo Alto, CA (US)

(21) Appl. No.: 14/893,840

(22) PCT Filed: Jun. 12, 2013
(86) PCT No.: PCT/US13/45416

§ 371 Date: Nov. 24, 2015

(51) Int. Cl. G06Q 10/06

(52) U.S. Cl. CPC G06Q 10/06313; G06Q 10/067

(57) ABSTRACT

Example embodiments relate to distributed worker-sourced process engineering. In some examples, a system may include a process portion input module to allow a worker to directly provide process statements to the system that indicate a local process portion that the worker performs. The system may include a statement verification module to dynamically verify the process statements of the worker as the worker provides them to aid the worker in entering the process statements. The system may include a process assembler module to automatically assemble an overall or global process or process portion based on the process statements of the worker and process statements of other workers, and provide the overall or global process or process portion to an analyst for review.

### BACKGROUND

An organization (e.g., an enterprise, company, firm, entity, etc.) may perform many different processes in order to carryout the business of the organization. The term business process (or just process) may refer to a collection of related and structured and/or orchestrated activities and/or tasks that serve a particular goal of the organization, for example, to provide a specific service or produce a specific product for a particular customer or customers. A business process may be decomposed into several sub-processes, activities, tasks and the like, which may be performed across different teams, organizations or regions of the world. The organization may prefer to specify best practices for these processes and/or analyze the processes that are in place, for example, to improve the processes. The analysis of a business process typically includes creating a business process model (BPM) that represents the ways in which sub-processes, tasks, operations and the like of the process are carried out to accomplish the intended goal of the organization. A business analyst may analyze and interact with the business process model, for example, to improve process efficiency and quality.

Various tools may be used to model or engineer a business process. Such tools may provide the ability to model a business process, and perhaps implement and execute such a model. Such tools may allow an analyst to refine the model, e.g., based on how the model executes in response to certain data. In other words, such tools may allow for simulation of a business process (e.g., “what-if” analysis). Such tools may provide a graphical user interface (GUI) to users of the tool, and may provide a graphical representation of business process modeling. Example standards include Business Process model and Notation (BPMN), Event-driven Process Chain (EPC) and Unified Modeling Language (UML). Such tools may use a programing language or syntax (called business process modeling language of BPML) to specify actions within the business process and details about such actions. The programming language used may be related to the standard used; however, more than one language may be used for a single standard.

### BRIEF DESCRIPTION OF THE DRAWINGS

The following detailed description references the drawings, wherein:

FIG. 1 is a block diagram of an example network setup where distributed worker-sourced process engineering may be used in such a setup;

FIG. 2 is a block diagram of an example worker service to facilitate distributed worker-sourced process engineering;

FIG. 3 is a diagram of an example display that may be provided to at least one worker by a graphical user interface of an example worker service;

FIG. 4 is a block diagram of an example analyst service to facilitate distributed worker-sourced process engineering;

FIG. 5 is a flowchart of an example method for distributed worker-sourced process engineering;

FIG. 6 is a block diagram of an example process engineering computing device 600 for worker-sourced process engineering; and

FIG. 7 is a flowchart of an example method for worker-sourced process engineering.

### DETAILED DESCRIPTION

As described above, a business process may be decomposed into several sub-processes, activities, tasks and the like, which may be performed across different teams, organizations or regions of the world. For example, an organization (e.g., an enterprise, company, firm, entity, etc.) may have several workers (e.g., human workers, knowledge workers, etc.) performing different portions of a process, perhaps across different teams, organizations or regions of the world. An organization's business process may ideally govern the manner in which these workers perform the process portions, and, as described above, the organization may attempt to specify best practices for these processes. However, with many workers in many different teams, organizations and geographic regions, different workers may perform a process portion in different ways, for example, to accommodate regional/geographic differences, local policies, to cater to specific customer situations, etc. With such diversity, it may be difficult for an analyst to understand the overall (i.e., global) process. In various scenarios, for example, in the case of a large worldwide organization, an analyst may not know significant amounts of information about the organization's business processes that are in place, and may be interested to learn more about a process, for example, to improve it.

It may be difficult for an analyst to learn about how a business process is enacted by various workers in various regions of the world. For many business processes that include tasks performed by workers, the workers are the ones that perform the actual tasks of the process, and they may have the best knowledge about the portion of the process in which they are involved. Therefore, gaining knowledge from these workers may be one of the most useful ways to learn about the process currently in place.

Some approaches to process modeling or engineering include having consultants or business analysts within the organization interview workers of the organization, often only a sample (e.g., a small sample) of the workers. Such consultants or analysts may then manually document or enter (e.g., into a business process modeling tool) the information gained from the workers to detail the overall (i.e., global) process. Such approaches may be a centrally focused (e.g., analyst-centric or analyst-sourced) effort based on the understanding of the consultants/business analysts. In other words, such approaches are implemented in a “top down” manner, meaning that analysts (e.g., a select number of analysts) representing the top organization look down at the departments of the organization, then the teams of workers, then the workers, etc. Using such approaches, important information from the workers may be lost, for example, due to incorrect interpretation by the consultants/analysts or due to the small size of the worker sample group. Such approaches to process modeling or engineering may be labor intensive, tedious, time consuming, costly and error-prone. Once the consultants/analysts interview various workers (e.g., from around the world), the consultants/analysts must review and reconcile (e.g., manually) the results, investigating any discrepancies, so that an overall (i.e., global) business process model can be created. Once such review is done, the resulting business process model likely still does not include all process variations (e.g., across various departments and regions of the world), and is thus, incomplete.

Moreover, business process modeling tools are not designed to be human-friendly, and thus, errors in interpretation by consultants/analysts and incomplete models may not be cured by allowing workers to enter process details directly into a business process modeling tool. Such tools are designed for use by trained and experienced business analysts that understand the complexities of the business process modeling standards and business process modeling languages used. Thus, workers, who know the details of the process work the best, may not understand how to use such tools. For example, the workers may not be familiar with the syntax of the process modeling standard and/or languages. Additional, graphical interfaces of such tools may be confusing and intimidating to workers. Indeed, such process modeling tools and approaches target more specialized and expert business process analysts.

The present disclosure describes distributed worker-sourced process engineering. The present disclosure describes a “bottom up” approach to providing details about a business process, for example, starting with direct input from individual workers, and building up to a complete business process of an organization. The present disclosure allows workers to engage directly with a process engineering system, to provide details about the work the do (e.g., a local process portion), work that is part of an overall or global process. Such a process engineering system may allow such workers to enter details about their work by selecting from a set of defined process statements may be of an easy to understand, human-friendly, textual language (e.g., a language closely resembling natural language). Various portions of an overall or global process may be entered by workers across various teams, departments, and regions of the world. Thus, process portions may be received by the system in a distributed manner. The process engineering system may automatically assemble the process statements into an overall or global process or process portion, considering the variations of the process statements from various workers. The process engineering system may translate the overall/global process/process portion from the human-friendly, textual syntax to a process modeling standard, which may subsequently be verified by a business process model verification service.

The present disclosure may provide benefits over other approaches to process modeling. For example, the present disclosure may allow business analysts to view process information from distributed workers and/or teams of workers across the world. It may also allow an analyst to view how the same process/sub-process is done in different contexts, settings and regions. The present disclosure facilitates the workers in expressing their view of the process and aids the analysts in recording and understanding the whole business process and its variations in different regions, teams, or based on other contextual criteria. Workers may easily and directly interact with the system of the present disclosure and thus the input of many workers may be used to formulate the business process, as opposed to a small sample of workers. Additionally, because workers may enter their information directly into the system, errors may be reduced or eliminated that may occur otherwise due to a consultant or analyst interpreting a worker's response to an interview question.

The term “knowledge worker” or simply “worker” may be used herein to refer to an individual that actually performs a portion of a process and has knowledge about the details of the portion of the process. The term “business analyst” or simply “analyst” may be used herein to refer to an individual (e.g., acting on behalf of an organization) to learn about and improve the business process of the organization. It should be understood that throughout this disclosure, when the term “analyst” is used, the description may also apply to individuals acting outside of the organization, but on behalf of the organization, such as a consultant. The term “business process” or simply “process” may be used herein to refer to a series or chain of related and structured activities, events and/or tasks that serve a particular goal or an organization. For example, a process may provide a specific service or product for a particular customer or customers. Specific examples of business processes, sub-processes, tasks, events and the like may be provided below. The terms “local” and “global” may be used throughout this disclosure as general terms that mean, essentially, “smaller” and “larger.” Thus, a global process or process portion does not necessarily mean a process/process portion that happens all over the globe. Instead, it may mean, generally, a larger process or process portion made up of smaller process portions (e.g., distributed process portions from knowledge workers).

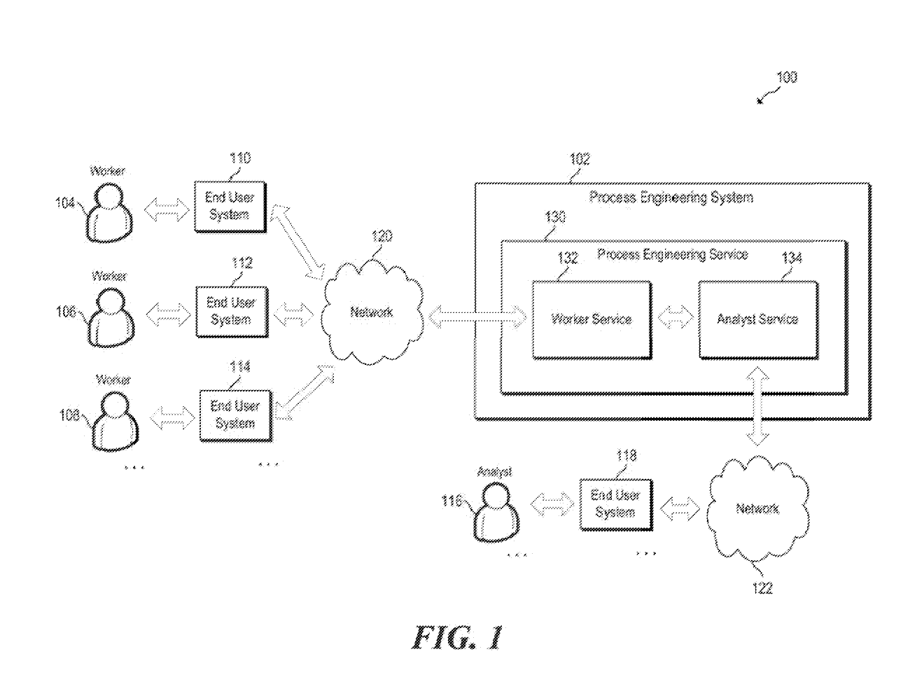

FIG. 1 is a block diagram of an example network setup 100 where distributed worker-sourced process engineering may be used in such a setup. Network setup 100 may include a process engineering system 102, as described in more detail below. Network setup 100 may include a number of workers 104, 106, 108, each being in communication with process engineering system 102, for example, via an end user system (e.g., 110, 112, 114). Workers 104, 106, 108 may communicate with process engineering system 102 (e.g., with worker service 132) to, among other things, provide details about process portions that the workers work on, as described in more detail herein. Network setup 100 may include a number of analysts (e.g., 116), each being in communication with process engineering system 102, for example, via an end user system (e.g., 118). Analyst 116 may communicate with process engineering system 102 (e.g., with analyst service 134) to, among other things, learn about an overall or global process that includes process portions worked on by workers 104, 106, 108 and perhaps other workers, as described in more detail herein.

Each user systems 110, 112, 114, 118 may each be any computing device that allows a user (e.g., a worker or analyst) to connect to a remote system or server (e.g., 102) via a network. End user systems 110, 112, 114, 118 may communicate with process engineering system 102 via at least one network (e.g., 120, 122). Networks 120, 122 may be a wired or wireless, and may include any number of hubs, routers, switches or the like. Networks 120, 122 may be, for example, part of the internet, at least one intranet and/or other types(s) of network(s). In some examples, networks 120, 122 may be the same network.

Process engineering system 102 may be implemented as at least one computing device, for example, any computing device accessible to workers and analysis over the internet or some other network. In some examples, process engineering system 102 may be implemented as more than one computing device, for example, computing devices that are in communication with each other (e.g., via a network). In these examples, the computing devices may operate together and provide a unified service to users. In these examples, the computing devices may be separate devices, perhaps geographically separate. The term “system” may be used to refer to a computing environment that includes one computing device or more than one computing device.

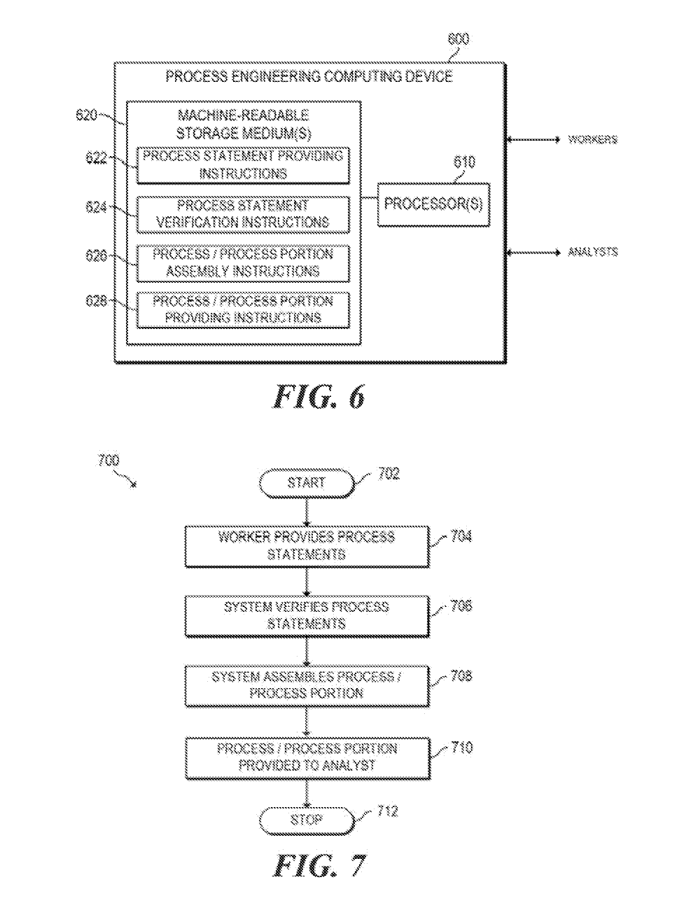

Process engineering system 102 may include a process engineering service 130. Process engineering service 130 may further include a worker service 132 and an analyst service 134. Process engineering service 130, worker service 132 and analyst service 134 may include a series of instructions encoded on a machine-readable storage medium and executable by at least one processor (e.g., processor 610 of FIG. 6) accessible by the process engineering system 102. In addition or as an alternative, process engineering service 130, worker service 132 and analyst service 134 may include one or more hardware devices including electronic circuitry for implementing the functionality described below.

Process engineering service 130 may establish a connection with end user systems of workers and analysts (e.g., systems 110, 112, 114, 118), for example, to allow workers to access worker service 132 and analysts to access analyst service 134. Process engineering service 130 may, for example, include a web server that allows web clients of the end user systems to connect to the process engineering service 130.

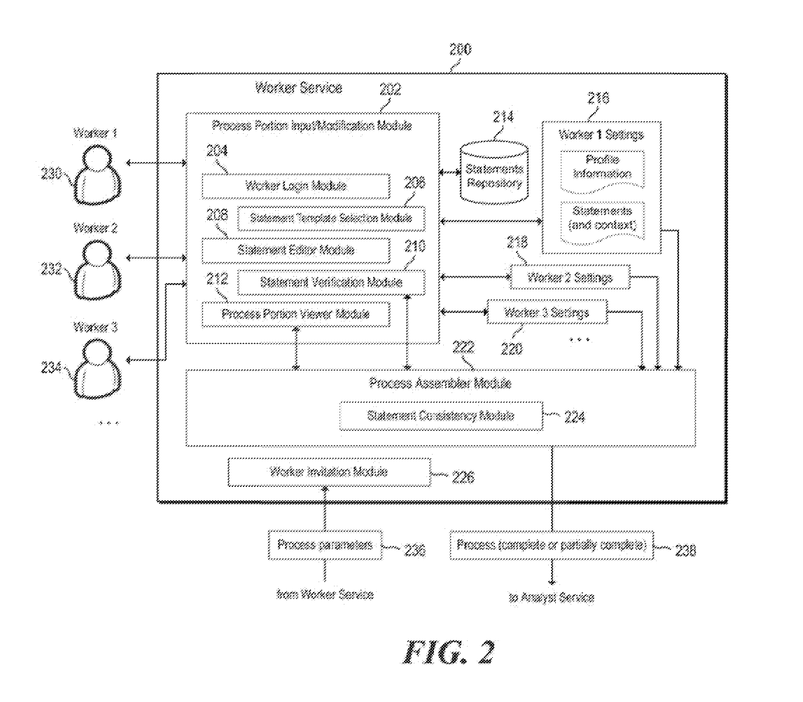

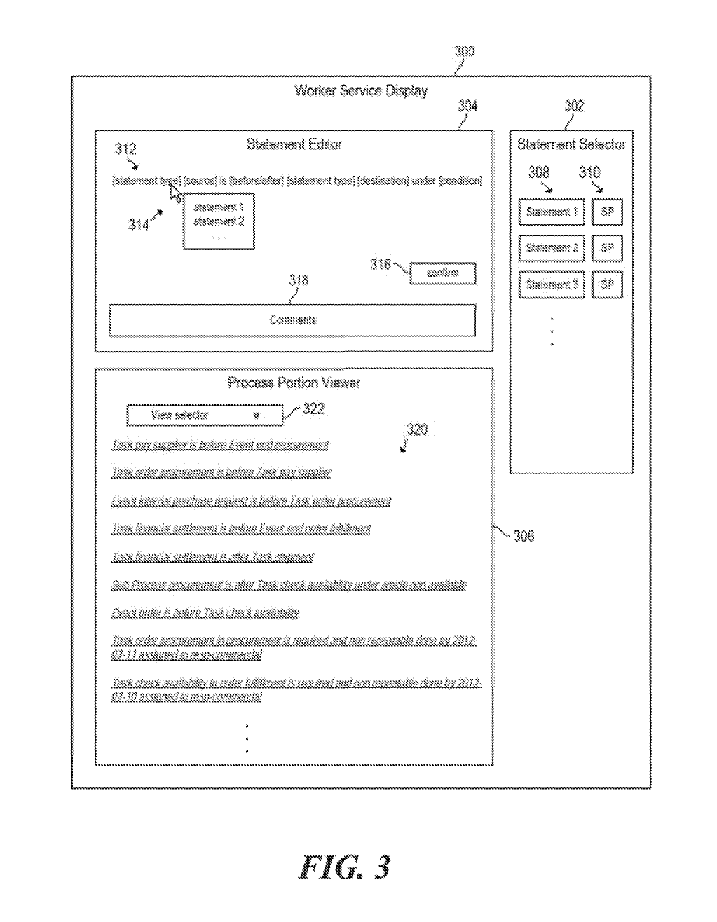

Worker service 132 may communicate with workers (e.g., via end user systems and a network) to allow workers to, among other things, provide details about process portions that the workers works on. More details of an example worker service may be described below with regard to FIG. 2. Analyst service 134 may communicate with analysts (e.g., via end user systems and a network) to allow analysts to, among things, learn about an overall or global process that includes process portions worked on by various workers, More details of an example worker service may be described below with regard to FIG. 3.

FIG. 2 is a block diagram of an example worker service 200 to facilitate distributed worker-sourced process engineering. Worker service 200 may be similar to worker service 132, for example. Worker service 200 may include a number of modules, for example, modules 202, 204, 206, 208, 210, 212, 222, 224, 226. These modules may include a series of instructions encoded on a machine-readable storage medium and executable by at least one processor (e.g., processor 610 of FIG. 6) accessible by the process engineering system that includes worker service 200. In addition or as an alternative, these modules may include one or more hardware devices including electronic circuitry for implementing the functionality described below. Worker service 200 may include a statements repository 214. The term repository may generally refer to a data store that may store digital information. Each repository may include or be in communication with at least one physical storage mechanism (e.g., hard drive, solid state drive, tape drive or the like) capable of storing information including, for example, a digital database, a file capable of storing text, settings or the like, or other type of data store. Worker service 200 may include a number of worker settings (e.g., 216, 218, 220), which may be implemented as at least one digital file, for example, stored in a database, repository or other type of data store.

Process portion input/modification module 202 may allow a number of workers (e.g., workers 230, 232, 234) to, among other things, provide details about process portions that the workers works on. As described in more detail below, process portion input/modification module 202 may provide workers with an editor where they can select and configure process statement templates, and may, for example, provide assistance by offering guidance with template arguments. Module 202 may include a number of modules, for example, modules 204, 206, 208, 210, 212. In some examples, workers (e.g., workers 230, 232, 234) may provide information to module 202 in response to receiving invitations (e.g., email notifications, pop-up windows or the like) from the worker service 202, for example, via worker invitation module 226, as described in more detail below.

Worker login module 204 may allow workers to log in to the worker service 200, for example, to access worker settings (e.g., 216, 218, 220) that are respectively associated with the workers. For each particular worker, the worker settings (e.g., as shown in worker settings 216) may include profile information about the worker and process statements (and contextual information) associated with the worker. More details about process statements and contextual information may be described below. In an organization, each worker may be involved in performing only a portion of a larger process, and may only know details about the workers process portion or a process portion of the worker's team or location. Thus, it can be said that workers may have “local” knowledge about a “global” process. Workers may not know about other portions or details of the larger process. By logging into the worker service 202 (e.g., via module 204), each worker may only see information (e.g., statements, comments, etc.) that is related to the processes, sub-processes, tasks, etc. that that worker is working on, or that the worker's team is working on.

Process portion input/modification module 202 may provide a graphical user interface to workers (e.g., workers 230, 232, 234). The graphical user interface may be capable of providing various screens or displays that may provide various features and pieces of information to workers. Such screens or displays may be provided to workers via a web server connection, such that the screens or displays appear on end user systems (e.g., 110, 112, 114) associated with the workers. The graphical user interface may also allow workers to submit or enter information, make selections and the like. Workers may perform such operations by interacting with their end user systems. In general, and as described in more detail below, the graphical user interface may allow such workers to enter details about their work by selecting from a set of defined process statements and configuring the selected process statements.

FIG. 3 is a diagram of an example display 300 that may be provided in at least one worker by a graphical user interface of the process portion input/modification module 202. Display 300 may include a statement selector 302, a statement editor 304 and a process portion viewer 306. Statement selector 302 may generally be associated with statement selection module 206 of FIG. 2. Statement editor 204 may generally be associated with statement editor module 208 and/or statement verification module 210 of FIG. 2. Process portion viewer 306 may generally be associated with process portion viewer module 212 of FIG. 2. Therefore, statement selector 302, statement editor 304 and process portion viewer 306 may be described in more detail below along with the discussion of these associated modules.

Referring again to FIG. 2, statement selection module 206 may allow workers to enter details about their work by selecting from a set of defined process statement templates, for example, process statement templates stored in statements repository 214. The term “process statement” may refer to a textual identifier of a component of a process (e.g., one activity that a worker may perform in the context of a larger process or process portion), and multiple process statements may be combined to specify, or describe a process or a portion of a process. Process statements may be the building blocks used by a worker to describe a portion of a process that the worker works on. The term “process statement template” or just “statement template” may refer to a shell or base of a process statement that may be used to indicate one type activity that a worker may perform. A process statement template may need to be configured by a worker before it is a process statement. A process statement template may resemble a function call, for example, in a high-level programming language, in that each process statement template may include at least one argument that may be provided by a worker. However, it should be understood that process statement templates and process statements in general may be of a human-friendly, textual language (e.g., closer to a natural language and less like a machine-oriented language).

As indicated, process statements and process statement templates may be provided in an easy to understand, human-friendly, textual (e.g., as opposed to code-based) language, for example, a language closely resembling natural language. This may allow workers to understand the process statements even if such workers are not familiar with business process modeling standards or languages. The human-friendly, textual language may include a limited set of process-related vocabulary from process modeling standards or languages) such that the language is structured enough to later be translated into a formal business process modeling standard and/or language. Yet, the language may be close enough to natural language such that workers unfamiliar with business process modeling may quickly learn the language.

The following will describe some example process statements, process statement templates and examples of configuring statement templates by providing arguments. The following will also show an example human-friendly, textual language used for process statements and process statement templates. It should be understood that this is only one example, and other types of statements and/or languages may be used. Table 1 below shows a number of process statement types that may be included in a process statements repository (e.g., 214). A statements repository may have more statement types than those listed below. Each process statement type has an associated process statement template. As described more below, a worker may select a process statement template and configure it to create a process statement. As can be seen in Table 1, each process statement (e.g., the syntax) is expressed in a human-friendly, textual language.

TABLE 1

| Process Statement Type | Process Statement Template (Syntax) |
|---|---|
| Process | Process {name} [carried out at {region}] [in {industry/segment}] |
| | [for {deal type}] |
| Sub Process | Sub Process {name} in {parent Process} [carried out at {region}] |
| Task | Task {name} in {parent Process/Sub Process} is {optional/ |
| | required} and {repeatable/non-repeatable} [done by {due date}] |
| | assigned to {actor} |
| Start Event | Start Event {name} in {parent Process/Sub Process} [triggered by |
| | {condition/receiving message/date}] |
| Intermediate Event | Intermediate Event {name} in {parent Process/Sub Process} |
| | [triggered by {condition/receiving message/sending message/ |
| | date}] |
| End Event | End Event {name} in {parent Process/Sub Process} [triggered by |
| | {sending message}] |
| Statement Ordering | {Task/Event/Sub Process} {source} is {after/before} {Task/Event/ |
| | Sub Process} {destination} [under {condition}] |
| Data association | {Task/Sub Process/Event} has {date} as {input/output/local} |

As can be seen in Table 1, the process statement templates may include portions shown in square brackets (“[ ]”) and/or portions shown in curly brackets (“{}”). These portions may be referred to as “arguments” and may be configurable by a worker. Square brackets may indicate optional arguments (e.g., a worker must provide a value for the process statement to be complete) and curly brackets may indicate mandatory arguments (e.g., a worker may or may not provide a value). For example, in the “process” type statement template, “name” is a mandatory argument. As another example, “carried out at {region}” is an optional argument. Additionally, it may be seen that mandatory arguments may be included within optional arguments (and vice versa). For example, if a worker chooses to provide the “carried out at (region)” argument, then the “region” argument is mandatory. Additionally, text in a statement template that is not contained between brackets, (e.g., immediately adjacent brackets) may be a keyword. For example, referring again to the “process” type statement template, “carried out at,” “in” and “for” may all be keywords. Keywords may generally provide a human-friendly, textual indication of the purpose of an argument that may follow.

As can be seen in Table 1, a first type of process statement may be called a “process.” In general, a process indicates the overall (i.e., global) process. For example, a process may be a purchase process, which may include all the steps from the purchase of a good to supplying the good to the purchaser. A worker may configure the various arguments of the “process” type statement template. For example, the worker may configure the name, the region, the industry/segment, and the deal type. It may be described in more detail below how a worker may configure these portions. Another type of process statement may be called a “sub-process.” In general, a sub-process may describe a portion of a process, and may include multiple tasks. For example, a purchase process may include sub-processes such as ordering, payment, shipping, etc. The template of the sub-process statement also includes configurable portions (arguments). Some of these portions (e.g., region) may be auto configured based on the configurations of the parent process.

As can be seen in Table 1, another type of process statement may be called a “task.” In general, a task may describe a smaller unit of work than a sub-process, and may represent the smallest unit of work that a worker can specify. For example, if an example process was a sales process, and the sub-process was a pricing sub-process, then example tasks may include pricing software, pricing hardware, etc. As another example, for a shipping sub-process, example tasks may include packaging, posting, etc. The template of a task statement also includes configurable portions (arguments). For example, a task may be part of a parent process or sub-process. As another example, a task may be assigned to an “actor,” which may indicate, for example, a username associated with a worker or a worker's role.

As can be seen in Table 1, another type of process statement may be called an “event.” In general, an event statement indicates some action that is performed when some trigger occurs (e.g., an external trigger). For example, a worker may specify that whenever a new order arrives (the external trigger), the worker performs some action. Multiple types of event process statements may be used by the system. For example, as shown in Table 1, process statement types of “start event,” “intermediate event,” and “end event” may be used. A start event may indicate some event that causes a process or sub-process to begin. An intermediate event may indicate some trigger that occurs in the middle of a process or sub-process, and how such a trigger is handled. For example, if a customer cancels their order (trigger) in the middle of order processing (task), a worker may refund the customer's money. An end event may describe some action that occurs at the end of a process or sub-process. For example, once an order is processed, the worker may send out a confirmation or denial that the order has been processed successfully. The template of event statements also includes configurable portions (arguments). As one example, the parent process or sub-process of the event may be configured, and may be auto configured by the system based on a previous process or sub-process referred to by the worker.

As can be seen in Table 1, another type of process statement may be called “statement ordering.” In general, statement ordering indicates that one or more process statements occur before one or more other process statements. For example, a statement ordering process statement may indicate that a task of approving an order occurs after the task of checking permits. A statement ordering may indicate that a worker checks that the order is as specified before the worker verifies that a certain process or sub-process is complete. The template of statement ordering statements also includes configurable portions (arguments). Another type of process statement may be called “data association.” In general data association may specify details about the input, output, etc. of a process, sub-process or task. For example, for an order task, a data association process statement may specify details about invoice data. As another example, a data association process may specify that the input to a first task is the output from another task. In this respect, the data of these two tasks are associated, and may later be used to verify process statements.

With the descriptions of example process statements above, and referring again to FIG. 2, statement selection module 206 may allow workers to see a list of all the process statements types/templates that are available (e.g., in statements repository 214), and may allow workers to select process statement templates to create process statements that will be used to indicate the work the workers perform. Statement selector 302 of display 300 of FIG. 3 may display the available statement types 309 (e.g., generally indicated by statement 1, statement 2, statement 3, etc.) to a worker. Also, statement selector 302 may display, for each statement type, a link or button 310 that allows a user to navigate to a statement page for the statement type. The statement page may be described in more detail below. A worker may select a particular statement type by interacting with statement selector 302, for example, by moving a pointer (e.g., 314) over the statement type and clicking or activating the pointer. Once a particular statement type is selected, a statement template 312 for the statement type may display in statement editor 304 of FIG. 3.

Referring to FIG. 2, statement editor module 200 may allow workers to configuring selected process statement templates. As can be seen in FIG. 3, a statement template 312 associated with a selected statement type (e.g., from 308) may be configured by a user via statement editor 304. For example, a user may select (e.g., click on) one of the arguments of the statement template, and then the user may enter at least one value to become part of the statement. Such argument values may form inputs, outputs, contextual information and the like for the process statement. In some situations, a user may freeform enter values for the arguments. In some situations, the system may supply or suggest options of values for the user to select, where the selected value may be used for the statement. Suggested values may be provided in various ways, for example, via autocomplete, a dialogue box with a list of values or the like. As one example, as shown in FIG. 3, statement template 312 is a statement template for an “event” process statement, and one of the arguments (e.g., the first argument) is a “statement type.” In this example, when the user clicks the argument (e.g., with pointer 314), the system may provide suggested value options (e.g., via a dialogue box near pointer 314). In this example, the value options include available types of statements, as shown in FIG. 3. As described more below, value options for arguments may also be provided to a worker based on verification of the statement by the system. Thus value options may aid the worker in creating a statement with proper syntax or a statement that is consistent with other statements of the worker or other workers.

Once a worker is done configuring all the arguments of the statement template 312, the worker may select a button (e.g., confirm button 316) to indicate that the statement template 312 should be saved for the worker as a process statement that indicates a part of the work the worker performs. Saved process statements for a particular worker may be stored in the workers settings (e.g., 216, 218, 220) for the particular worker. Then, these settings may be accessible by process assembler module 222, as described in more detail below. Workers may be able to access saved statements in their user account. Workers may be able to select saved statements after they are saved and edit those statements, for example, using statement editor 304.

Whether statement editor module 208 and/or statement editor 304 suggests value options for statement template arguments or not, the system may check the correctness of the statement in editor 304, for example, using statement verification module 210. The correctness of the statement may be cheeked after the worker has indicated that the statement should be saved (e.g., by clicking button 316), or at other times. For example, the correctness of the statement may be checked “on the fly” or dynamically whenever a worker selects or enters a new value for an argument of the process statement template 312. Statement verification module 210 and/or statement editor 304 may check the statement in various ways. For example, the statement (e.g., the argument values/inputs and outputs) may be checked for proper statement syntax (e.g., as specified by a human-friendly, textual language used for process statements). Additionally, the statement may be checked for consistency with other process statements, e.g., process statements already saved by the worker and/or other workers (e.g., globally or within the worker's team). When statements are checked, statement verification module 210 and/or statement editor 304 may provide suggestions or options for the worker to use in order to cure any problems with the statement. More details regarding checking for consistency may be provided below with regard to process assembler module 222 and/or statement consistency module 224.

Process assembler module 222 may receive process statements from various workers, for example, all the workers in a particular team or all the workers in the entire organization. As shown in FIG. 2, module 222 receives information from the worker settings (e.g., 216, 218, 220) of various workers, including process statements input and saved for the various workers. Such process statements may have been completed by the workers, for example, by supplying values for all the arguments of the related statement template. In this respect, each of the process statements received by module 222 may have “context” as described in more detail below.

As described above, the present disclosure describes a “bottom up” approach to process engineering. Process assembler module 222 plays a role in this bottom up approach by receiving process portion information from various workers (e.g., in a distributed manner) and automatically assembling the portions in a larger portion or perhaps a complete process 238). It may also be said that the process portion information from the various workers is provided by the workers and received by module 222 in a “crowdsourcing” manner. In general, the term crowdsourcing may refer to various users acting on their own to provide personal or local information that may then be assembled by a system into a larger or global view. In the context of this disclosure, the term “worker-sourced” or “worker-sourcing” may be used in a manner very similar to crowdsourcing, where various workers may act on their own to provide personal or local information that may then be assembled by a system into a larger, overall or global view.

Process assembler module 222 may analyze the received process statements and attempt to piece them together into a larger process portion, perhaps building up to a complete process. For example, the process statements from one worker may be assembled with the process statements from another worker and so on. Module 222 may then send the larger process portion or full process 238 to an analyst service (e.g., 134 or 400) for analysis, as described in more detail below. Process assembler module 222 may include a statement consistency module 224.

Process assembler module 222 (e.g., via module 224) may detect inconsistencies among various received process statements. Inconsistencies may exist for various reasons, for example, due to an entry error by one or more workers or due to differences in how a process portion is performed due to location, specific clients, etc. As described above, statement verification module 210 may check process statements entered by workers, for example, to check for proper syntax. However, checking a process statement in isolation (e.g., without considering the larger process) may only allow for some errors to be caught. A process statement may appear to be correct when analyzed in isolation, but it may be incorrect or inconsistent when analyzed as it related to various other process statements. For example, if a first statement has output A, and a second statement is supposed to receive output A as an input, then, accidentally specifying that the first statement has output B instead of output A may cause problems, even though the first statement may appear correct in isolation. As another example, module 222 and/or 224 may check whether a statement (e.g., a sub-process statement) is really a child to an indicated process statement, for example, by checking various inputs, outputs, etc.

In some examples, module 222 may detect inconsistencies by detecting that two nearly identical process statements entered by two different workers are essentially detailing the same process step, but are different for some reason (e.g., because of different argument values). In some examples, module 222 may detect inconsistencies by detecting that, for example, a first process statement receives as input, a value that was never generated (e.g., as the output of another process statement). Then, by detecting that another process statement likely was intended to provide the output for the first process statement, process assembler 222 may determine what the input to the first process statement for output from the other process statement) should be in order for the statements to be consistent.

To detect various inconsistencies in process statements received by module 222, process assembler module 222 may use a set of consistency rules. Some consistency rules in the set may check for inconsistencies at the statement level; some may check for consistencies at the sub-process level; and some may check for consistencies at the process level. Process assembler module 222 may apply the various consistency rules via a process, algorithm, logic or the like. As one example, to detect duplicate statements, module 222 may use consistency rules that check at the sub-process or process level. Such roles may check the names of the process statements, and then may track what happens to each argument (e.g., input, output and the like) of each process statement. Two process statements may have similar inputs, outputs and input/output paths, but may have different names. Differences between process statements may be determined to be legitimate or acceptable if the arguments have different values and/or value paths, meaning that in different conditions the statements indicate that different tasks should be performed. Otherwise a warning may be issued to check for duplication. A similar process, algorithm, logic or the like may be used to detect un-used but generated arguments (e.g., inputs, outputs, etc.). For example, some inputs/outputs may be generated by one statement process but not used anywhere and are not input to another process statement.

Process assembler module 222 may provide information to statement verification module 210 in order to provide (e.g., via statement editor 304) inconsistency warnings and/or suggested changes to process statements to the workers that “own” the process statements. The inconsistency warnings and/or suggested changes may be based on inconsistencies detected by module 224) between various process statements and perhaps based on suggested fixes to process statements in order to make the statements consistent. Inconsistency warnings and/or suggested changes may be provided to workers “on the fly” (e.g., as users configure statement templates in editor 304) and/or after workers save their statements (e.g., via confirm button 316). In some situations, workers may receive inconsistency warnings and/or suggested changes as alerts (e.g., email notifications, etc.) later, and the workers may be invited to investigate the inconsistencies and/or make changes to their statements. Thus, it can be seen that either when a worker is configuring a process statement or perhaps later, the worker may be informed that the process statement is not consistent with other process statements of the same worker or other workers (e.g., in the same team and/or in the same organization). Workers can then make changes in order to achieve consistency or indicate or comment about the inconsistencies. Worker service 200 implements a sort of feedback cycle where workers configure process statements (e.g., at module 202), process statements are saved (e.g., at 216, 218, 220) and received by module 222, and inconsistency information is sent back to module 202 to aid in process configuration. Therefore, process assembler module 222 aids in reconciling the statements and inputs of various distributed workers.

Worker service 200 may provide a comment service for workers to comment on (and have conversations about) various items such as process statement templates/types, particular process statements and the like. The commenting service may be implemented in the worker service 200, or in the system (e.g., 102) that includes the worker service, or in an external system, in which case, worker service 200 may access such an external service and integrate it with the worker service to provide the commenting functionality described below. In some situations, various worker comments (e.g., from various workers) may be associated with each statement template/type. In this situation, the comments and/or conversations may be stored in the statements repository 214 or in some other repository of worker service 200. Information may also be stored that associates each comment with one of the workers. Alternatively, the comments may be stored externally, and information to link the comments to statement templates/types and/or workers may be stored in worker service 200. Alternatively, each workers comments may be stored in the worker's settings (e.g., 216, 218, 220), for example, along with information about which statement template/type, particular statement, etc. the comment is associated with.

The commenting service may support various channels or types of communication. e.g., beyond just simple text comments. For example, the commenting service may couple to at least one emailing service such that emails may be sent and receive by workers, where the emails may be related to process statement templates/types, particular process statements and the like. As another example, a worker may be able to record and/or submit a voice or video message or voice or video comment in a similar manner that a worker may submit a textual comment. As another example, multiple workers may record and/or submit a voice or video conversation related to process statement templates/types, particular process statements and the like. Therefore, various descriptions provided herein that refer to comments may be expended to include various other channels or types of communication.

The commenting service may allow workers to provide information about statement templates/types and/or particular statements for various reasons. For example, workers may provide information about how they configured a particular type of process statement template. In order to aid other workers (e.g., workers in the same team) in configuring their own process statements. As another example, workers may provide information about how they had to configure a particular process statement template in order to make it consistent with other process statements. As another example, workers may provide information that specifies that a particular inconsistency in a process statement is due to a particular difference in how the process is implemented (e.g., due to location, clients, etc.) for example, as opposed to an error. In this respect, various workers may indicate and explain (e.g., as an ongoing conversation) inconsistencies in various statements, and comments about inconsistencies may be provided (e.g., as annotations) to process statements, for example, when statements are provided to the analyst service. Additionally, as described more below, comments from various workers may appear, for example, via display 300, such that workers may see a “conversation,” which may allow workers to collaborate about how to use and configure process statements and about why legitimate inconsistencies may exist. In this respect, comments about statement templates/types may be implemented in a social networking or social collaboration manner. Workers within a team or even within an entire organization may discuss (e.g., within a conversation) how to use and configure process statements, perhaps considering various legitimate inconsistencies.

Workers may enter and view comments in various ways, for example, via various screens, displays and/or interfaces provided by process portion input/modification module 202. As one example, and referring to FIG. 3, statement editor 304 may include a comments area 318. When a worker is configuring a statement template 312 in statement editor 304, statement editor 304 may load and display comments associated with the same statement template/type in comments area 318. The worker may be able to see such comments while configuring the statement template. Additionally, the worker may enter and submit the worker's own comments about the statement template/type. It should be understood that when statements are entered in association with a statement template/type, the comments may be saved generally by the worker service as being associated with the statement template/type. Thus, comments entered for a statement template/type at one time via a particular screen, dialogue box, etc., may be viewable at a different time via a different screen, dialogue box, etc. if the worker is viewing comments about that statement, template/type.

As another example, workers may view and/or enter comments about a statement template/type by navigating in a “statement page” for a particular statement template/type. As is shown in FIG. 3, each statement type 308 in statement selector 302 may have an associated statement page (SP) 310. Each SP may be a hyperlink that when selected may cause display 300 to show a statement page for the particular statement type. Worker service display 300 may provide other ways for workers to navigate to statement pages. Each statement page may provide information that pertains to the particular type of statement. For example, the statement page may show the template for the statement type. The statement page may include examples of how various workers have configured the template for that type of statement This information may be provided by process assembler module 222, for example, after receiving information about statements from various workers. The statement page may include a comments area (e.g., similar to comments area 318 of FIG. 3), that may allow workers to enter and view comments about the statement template/type, in a similar manner to that explained above for comments area 318.

Referring to FIG. 2, process posters viewer module 212 may allow workers to view various statements that have been saved, statements that may make up a process portion or perhaps a complete process. Portion viewer module 212 may allow workers to view only their own statements (e.g., from the worker's settings) or statements from a group of workers (e.g., a team), or even statements from an entire organization. Process portion viewer module 212 may communicate with process assembler module 222 to access statements from various workers. In this respect, a worker may be able to see how the worker's own statement fit with statements of other workers to create a process portion. Additionally, workers may be able to see the inconsistencies that still exist (e.g., after workers have received and implemented suggested changes) between various statements of workers.

As can be seen in FIG. 3, a process portion viewer 306 may display various process statements 320 to a worker. The process statements 320 may be process statements that have been completed based on process templates, as described above. Such process statements 320 may have already been verified, at least to some degree, for example, to check for proper syntax and consistency with process statements of other workers. Process portion viewer module 212, process portion viewer 306 and the commenting service described above may allow workers to comment on particular statements/inconsistencies in the process statements 320. Such comments may be associated with particular statements/inconsistencies and may be referred to annotations. Annotations may explain why an inconsistency exists and why it may be legitimate. Such annotations may also be provided by workers when they are configuring process statements via editor 304, for example, if editor 304 notifies a user of an inconsistency “on the fly.” The process statements 320 shown in viewer 306 may update when workers save or confirm new process statements, for example, by selecting confirm button 316.

Process portion viewer 306 may include a view selector 322. View selector may allow a worker to select various views that may affect which process statements (e.g., 320) appear in viewer 306. For example, a worker may select to view only the worker's statements, in which case statements 320 may include only statements that the worker has selected (e.g., via selector 302) and configured (e.g., via editor 304) and saved. As another example, a worker may select (e.g., via selector 322) to view statements from the worker's team, in which case statements 320 may include statements saved from various workers within the worker's team, including the worker's own statements. In this example, the worker may see the worker's process statements and process statements of other workers as they fit within a global process or process portion. Various other viewing options are possible via selector 322. For example, statements may be filtered by various criteria such as process statement type (e.g., “task,” “event,” etc.), or other contextual information or criteria. Thus, while worker service 200 may allow workers to focus on their own portion of a process, workers may be able to view statements (e.g., reconciled statements) from team members, or perhaps from an entire organization, thereby allowing workers to view an aggregated sub-process or a complete process.

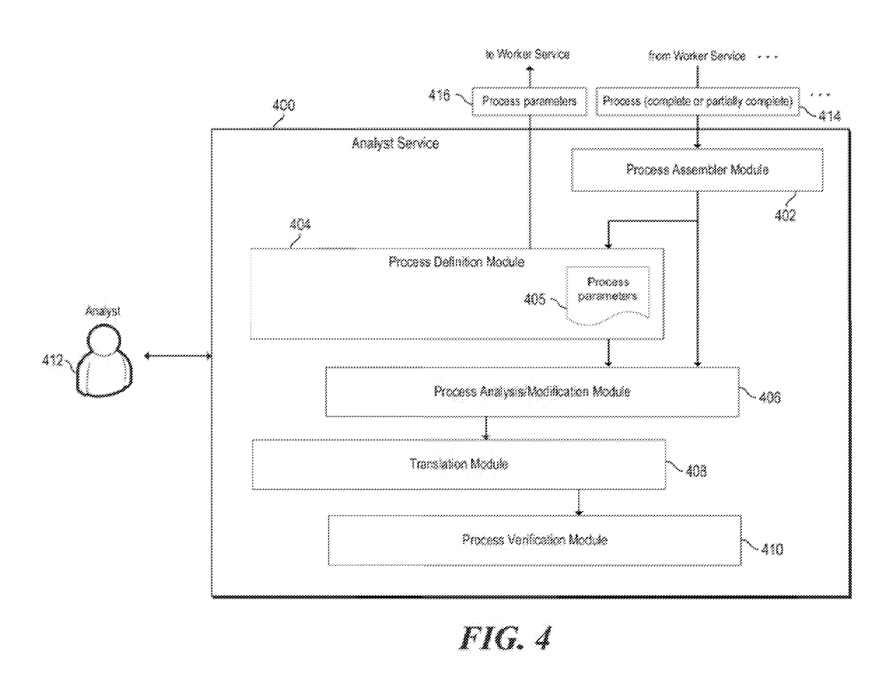

Process assembler module 222 may provide process statements from various workers to an analyst service (e.g., 134 or 400). Such process statements may form a complete or partially complete process 238. For example, if worker service 200 accepts statement inputs from all of the workers in an organization, then process 238 may be a complete process of the organization (assuming all workers entered their process statements). In some examples, a process engineering system (e.g., 102) may include more than one worker service, for example, where each worker service covers a segment (e.g., team, department, or group of teams, departments or the like) of an organization. In these examples, each worker service may include a process statement assembler module (e.g., 222) that outputs reconciled process statements for the group or workers that the worker service accommodates. In such a case, the analyst module may include its own process assembler module (e.g., 402 of FIG. 4) to assemble the process parts from the various worker services, as described below.

Process assembler module 222 may provide process statements in a dynamic manner, for example, such that an analyst service (e.g., 134 or 400) may continually view the process or process portion as it is built up with more and more input from workers. Alternatively or in addition, process assembler module 222 may notify the analyst service when process statements are ready to view, for example, after process statements provided by workers in response to an invitation are ready. Process assembler module 222 may provide the process statements from various workers as they have been configured by the workers. In other words, information 258 may include process statements and contextual information. Additionally, module 222 may provide at least some of the worker-provided comments and/or annotations regarding various process statements, for example, to aid an analyst and/or the analyst service in constructing the full process. For example, notations associated with particular statements and/or inconsistencies may travel with the statements (e.g., as part of information 238).

FIG. 4 is a block diagram of so example analyst service 400 to facilitate distributed worker-sourced process engineering. Analyst service 400 may be similar to analyst service 134, for example. Analyst service 400 may include a number of modules, for example, modules 402, 404, 406, 408, 410. These modules may include a series of instructions encoded on a machine-readable storage medium and executable by at least one processor (e.g., processor 610 of FIG. 6) accessible by the process engineering system that includes analyst service 400. In addition or as an alternative, these modules may include one or more hardware devices including electronic circuitry for implementing the functionality described below. Analyst service 400 may allow at least one analyst 412 to communicate with various modules of the analyst service, as described in more detail below. Analyst service 400 may receive a process (e.g., a complete process or a partially complete process) 414 from at least one worker service.

Process assembler module 402 may be present in analyst service 400, for example, if a process engineering system (e.g., 102) includes more than one worker service. In these examples, each worker service may output reconciled process statements, each forming a process portion or a partially complete process 414. Process assembler module 402 may assemble the process portions from the various worker services. Process assembler module 402 may operate in a manner similar to process assembler module 222 of FIG. 2. In this respect, process assembler module 402 may analyze the received process portions and attempt to piece them together into a complete process.

Process assembler module 402 may perform an initial verification (e.g., before the verification performed in process verification module 410). Process assembler module 402 may detect inconsistencies between the process portions 414 from various worker services. Even though each worker service may include a statement inconsistency module that may check for inconsistencies and errors in process statements, some errors may not be apparent when a portion of a process is analyzed in isolation. Process assembler module 402 may detect inconsistencies once the whole process is pieced together. For example, module 402 may detect that an input to one process statement from one worker service should be the same as an input to a process from another worker service. As another example, module 402 may detect that an input to a process statement is not defined. Process assembler module 402 may indicate (e.g., annotate) any inconsistencies that exist before module 402 passes the assembled process on to other modules of the analyst service 400 (e.g. module 404 and/or 408). In this respect, after module 402, a process may include inconsistency annotations that were provided by at least one worker service and/or process assembler module 402. These annotations may assist analyst to determine why process portions may be performed differently in different contexts.

Process definition module 404 may assist an analyst in specifying and defining a type of process that the analyst is interested in analyzing. As described above (e.g., in large entities). There may be many details about a process of the organization that the analyst does not know. Thus, an analyst may specify some pieces of information (i.e., process parameters 405) to indicate the process that the analyst would like to receive/view. For example, an analyst may specify that the analyst wants to see the organization's process (e.g., sales process, shipping process, etc.) for a particular type of sale or deal (e.g., deals of more than $500 million), for a particular region, etc. Example process parameters include type of process (e.g., sales, shipping, etc.), region, total contract value, industry segment, business unit and the like. Many other types of process parameters may be used for various other types of processes.

Process definition module 404 may use the process parameters 405 in various ways to receive and/or view relevant processes and process portions. As one example, analyst 412 may interact with process definition module 404 to enter process parameters 405 to indicate the type of process that analyst 412 is interested in. Then, module 404 (or some other modules of analyst service 400) may send such process parameters 416 to at least one worker service. The worker service (e.g., worker service 200) may then use the process parameters (e.g., shown as 236 in FIG. 2) to send invitations to workers associated with such a process (e.g., using worker invitation module 226). After the workers enter their process statements (or during the entry process), analyst service may receive one or more processes (or partial processes) 414 that are related to the process parameters 416. It should be understood that in various other examples, analyst service 400 need not send process parameters 416 to workers services, and workers services need not generate invitations to workers.

As another example process definition module 404 may use the process parameters 405 as a filter. In these examples, many processes (and partial processes) (e.g., 414) of the organization may be dynamically or constantly accessible to the analyst service 400. In other words, the various process statements entered by workers of an organization may be constantly updated and accessible to the analyst service as workers enter new statements. Then, when processes or partial processes (e.g., 414) are received by the analyst service (and perhaps pass through module 402),the processes/partial processes may be received by process definition module 404. Then, process definition module 404 may use process parameters 405 to filter out only processes/partial processes that meet the process parameters 405.

In order to filter out processes and/or process parts, process definition module 404 may compare process parameters 405 to the “context” of various process statements. The context of a process statement may be formed based on the values provided by workers for arguments (e.g., as shown in Table 1 above) of various process statements. Additionally, context of process statements may come from other sources such as the related workers profile information. For example context information may come from an LDAP directory or the like, that may provide information about users/workers, such as the workers group, job function, hierarchy, etc. Context information for a process statement may travel along with the process statement from the worker service, for example, as argument values and/or as additional information association with the process statement.

Process analysis/modification module 406 may assist an analyst to learn about a process or process portion and perhaps even discover processes of the organization. Process analysis/modification module 406 may receive at least one process or process portion from module 402 and/or from module 404 (e.g., if process filtering is performed). Once a process is received by module 406, the process may be assembled to form a complete process or a larger portion of a process including multiple related process statements. The process or partial process may have passed through at least one verification stage to check for errors and/or inconsistencies. Thus, at this point, the process or partial process may ideally only include inconsistencies that are legitimate (e.g., due to some actual different in implementation of the process as opposed to an error in entering the process statement). Inconsistencies may have been identified and/or annotated. Thus, analyst may be able to view (e.g., in a graphical and/or textual manner) all the process statements of the process or such inconsistencies. In this respect, the analyst may be able to pin a complete picture of the business process, and the analyst may learn about inconsistencies and determine strategies to manage them.

Process analysis/modification module 406 may allow an analyst to modify the process. Process analysis/modification module 406 may allow an analyst to checking the consistency of the process/process portion from module 404 and/or module 406 and act to fix various process statements, for example. In response to annotations and/or warnings provided by other modules and/or services of the system (e.g., the worker service, module 402, etc.). As one specific example, fixing process statements may entail an iterative process, where the workers provide process portion details, the system (e.g., its various modules and services) check for inconsistencies and errors, and then the analyst modifies the process and/or suggests changes to the process portions. Additionally, module 406 may allow an analyst to provide additional annotations that explain inconsistencies between process statements.

Translation module 408 may receive a process complete or partially complete) from module 406, or perhaps from module 402 or 404. The received process or process portion may be defined in a human-friendly, textual language as entered by the various workers, as described above. Translation module 408 may automatically translate the process from the human-friendly, textual language to a process modeling standard (e.g., BPMN). For example, module 408 may translate the process from the human-friendly, textual language to an XML format (or other markup language) where the data is formatted according to the modeling standard. Thus, at this point, various reconciled process statements provided directly by workers may be translated into a process modeling standard that can then be further analyzed by business process modeling/engineering tools. Using such tools, the data in the process modeling standard format (e.g., XML format) may be represented in multiple ways, for example, graphically, textually, in a particular programming language, etc.

Process verification module 410 may receive at least one process or partial process from translation module 408. Process verification module 410 may use a format process verification tool (e.g., based on Petri Net formalism or the like) to formally verify the correctness of a process. Process verification module 410 may perform formal verification on received processes or process portions that are formatted according to a process modeling standard (e.g., BPMN), as described above. Formal process verification tools may perform verification on executable business process languages, so module 410 may first convert the process from a process modeling standard to a particular process modeling language before performing formal verification. Then, a formal process verification tool may perform extensive analysis of the process or process portion to check for various issues, for example, fragmented process parts, gridlocks or endless loops, etc.

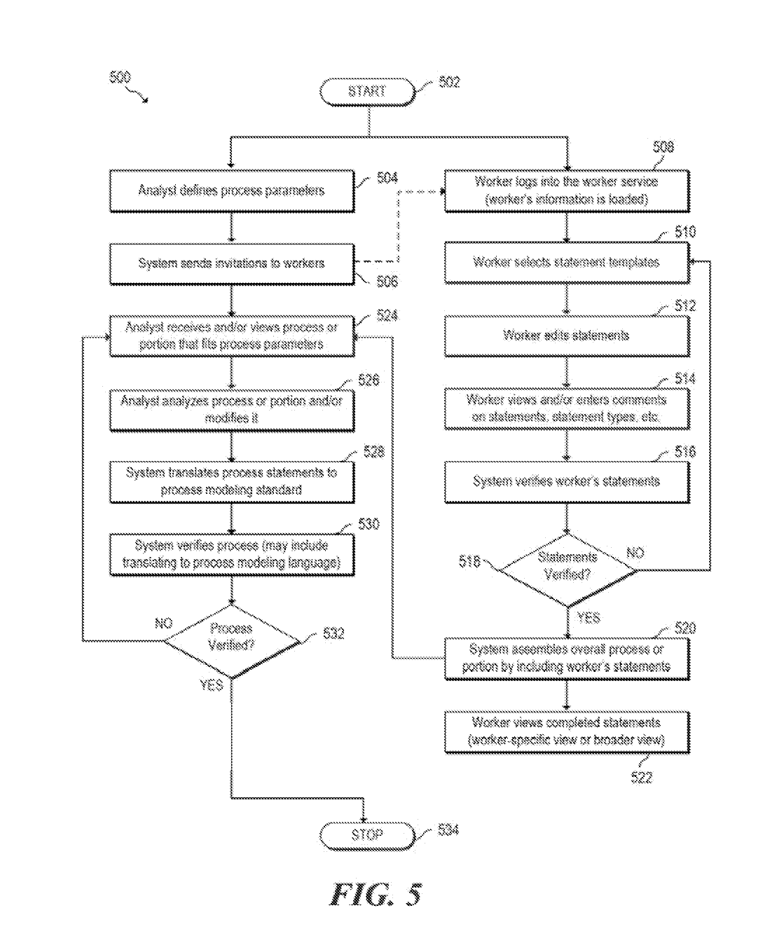

FIG. 1 is a flowchart of an example method 500 for distributed worker-sourced process engineering. Although execution of method 500 is described below with reference to process engineering system 102 of FIG. 1, part or all of method 500 may be executed by at least one other suitable computing device and/or system, for example, device 600 of FIG. 6. Method 500 may be implemented in the form of executable instructions stored on a machine-readable storage medium, such as storage medium 620 of FIG. 6. In alternate embodiments of the present disclosure, one or more steps of method 500 may be executed substantially concurrently or in a different order than shows in FIG. 5. In alternate embodiments of the present disclosure, method 500 may include more or less steps than are shown in FIG. 5. In some embodiments, one or more of the steps of method 500 may, at certain times, be ongoing and/or may repeat. It should be understood that the term “flowchart” is not intended to be limiting and FIG. 5 may also be said to depict a process-type diagram. For example, it may be allowable in method 500 that a single step or block may have multiple inputs and/or outputs.

Method 500 may start at step 502 and continue to step 504, where a process engineering system (e.g., 102 of FIG. 1) may allow an analyst to define (e.g., via module 404) process parameters that indicate a type of process that the analyst is interested in. At step 506, the system may send invitations to workers where the invitations request input from workers regarding processes and/or process portions that meet the process parameters. It should be understood that in some examples, invitations may not be sent. At step 508, various workers may log in (e.g., via module 204) to a worker service (e.g., 200), and each worker's information (e.g., settings, process statements, etc.) may be loaded. Workers may then proceed to provide information about process portions that the workers work on. Workers may log on to the system to enter such information in response to receiving an invitation. Alternatively, workers may log on and provide information whenever the workers see fit. Alternatively, workers may be asked to log on periodically or regularly (e.g., each month) and detail the process portions they work on.

At step 510 a worker (e.g., worker 230 of FIG. 2) may select (e.g., via module 206 and selector 302) process statement templates (e.g., stored in repository 214). Selecting a template may cause the template to appear in a statement editor (e.g., 304 of FIG. 3). At step 512, the worker may edit (e.g., via module 208 and editor 304) the selected process statement templates (e.g., one at a time). At step 514, the worker may view and/or enter comments about various statements, statement types and the like as described in more detail above. At step 516, the system may verify (e.g., via module 210, 222, 224, etc.) the worker's statements, as described in more detail above. For example, the system may verify the syntax of the statements and/or the consistency of the statements with other statements of the worker and/or of other workers. At step 518, if the worker's statements are verified, the worker's statements may be saved (e.g., in the worker's settings such as 216) in a reconciled format to be assembled with the statements of other workers. If the worker's statements are not verified, the worker may be notified and the worker may have the option to re-enter the statements or modify the statements (e.g., shown in method 500 as returning to step 510). It should be understood that even though method 500 and the preceding description refers to process statements collectively being entered, edited, commented upon and verified, each statement may individually go through the step 510, 512, 514 and 516, as described above.

At step 520, the reconciled statements of the worker may be assembled (e.g., via module 222) with statements of other workers to form an overall process or process portion. At step 522 the worker may view (e.g., via module 212 and view 306) completed statements of the workers own and/or of other workers. At step 524, the assembled statements (e.g., from step 520) may be received by the analyst service. As described above, the analyst service may receive specific processes and/or portions that fit the process parameters or the analyst service may filter out various received processes and/or portions to view those that are relevant to the process parameters. At step 526, the system may allow an analyst to analyze the process or portion and/or modify it. At step 528, the system may translate the process statements of the process or portion to a process modeling standard. At step 530, the system may verify the process or portion. This verification may require the process modeling standard to be translated into a particular process modeling language before verification can commence. At step 532, it the process fails to be verified, the analyst may return to step 524 to receive and/or view the process or portion again, ideally an updated process/portion. Method 500 may eventually continue to step 534, where method 500 may stop.

FIG. 6 is a block diagram of an example process engineering computing device 600 for worker-sourced process engineering. Process engineering computing device 600 may be any computing device accessible to at least one worker and at least one analyst, for example, over the internet or some other network. In some embodiments, process engineering computing device 600 may actually be more than one computing device, in which case, multiple processors and/or machine readable mediums may be involved. More details regarding an example process engineering system and/or service may be described above, for example, with respect to process engineering system 102 of FIG. 1, process engineering service 130 of FIG. 1, worker service 200 of FIG. 2 and analyst service 400 of FIG. 4. In the embodiment of FIG. 6, process engineering computing device 600 includes at least one processor 610 and at least one machine-readable storage medium 620.

Processor 610 may be one or more central processing units (CPUs), CPU cores, microprocessors, and/or other hardware devices suitable for retrieval and execution of instructions stored in a machine-readable storage medium (e.g., 620). Processor 610 may fetch, decode, and execute instructions (e.g., instructions 622, 624, 626, 628) to, among other things, perform worker-sourced process engineering. With respect to the executable instruction representations (e.g., boxes) shown in FIG. 6, it should be understood that part or all of the executable instructions included with one box may, in alternate embodiments, be included in a different box shown in the figures or in a different box not shown.

Machine-readable storage medium 620 may be any electronic, magnetic, optical or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within a computing device (e.g., 600), as shown in FIG. 6. In this situation, the executable instructions may be installed on the computing device. Alternatively, machine-readable storage medium 620 may be a portable (e.g., external) storage medium, for example, that allows a computing device (e.g., 600) to remotely execute the instructions or download the instructions from the storage medium. In this situation, the executable instructions may be part of an installation package. As described below, machine-readable storage medium 620 may be encoded with executable instructions to perform worker-sourced process engineering.

Process statement providing instructions 622 may allow a worker to directly provide process statements to the system that indicate a process portion that the worker performs. More details regarding providing process statements may be described above, for example, with regard to modules 206 and 208 of FIG. 2. Process statement verification instructions 624 may dynamically verify the process statements of the worker as the worker provides them to aid the worker in entering the process statements. More details regarding process statement verification may be described above, for example, with regard to modules 210, 222 and 224 of FIG. 2. Process/process portion assembly instructions 626 may automatically assemble a process or process portion based on the process statements of the worker and process statements of other workers. More details regarding process assembly may be described above, for example, with regard to module 222. Process/process portal providing instructions 628 may provide the process or process portion to an analyst for review. More details regarding providing process/process portions to an analyst (e.g., to an analyst service) may be described above, for example, with regard to module 222.

FIG. 7 is a flowchart of an example method 700 for worker-sourced process engineering. Method 700 may be executed by a process engineering computing device, for example, similar to process engineering computing device 600 FIG. 6. Method 700 may be executed by other suitable systems and/or computing devices, for example, process engineering system 102 of FIG. 1. Method 700 may be implemented in the form of executable instructions stored on a machine-readable storage medium, such as storage medium 620, and/or in the form of electronic circuitry. In alternate embodiments of the present disclosure, one or more steps of method 700 may be executed substantially concurrently or in a different order than shown in FIG. 7. In alternate embodiments of the present disclosure, method 700 may include more or less steps than are shown in FIG. 7. In some embodiments, one or more of the steps of method 700 may, at certain times, be ongoing and/or may repeat.

Method 700 may start at step 702 and continue to step 704, where a worker may provide (e.g., via instructions 622) process statements, e.g., directly to a process engineering computing device (e.g., 600) or system. At step 700, the computing device or system may verify (e.g., via instructions 624) the process statements, as described in more detail above. At step 708, the computing device or system may assemble (e.g., via instructions 626) the process statements of the worker and process statements of other workers into an overall process or process portion. At step 710, the process or process portion may be provided via instructions 628) to an analyst for review. Method 700 may eventually continue to step 712, where method 700 may stop.

It will be appreciated that the previous description of the disclosed examples is provided to enable any person skilled in the art to make or use the present disclosure. Various modifications to these examples will be readily apparent to those skilled in the art, and the general principles defined herein may be applied to other examples without departing from the spirit or scope of the disclosure. Thus, the present disclosure is not intended to be limited to the examples shown herein but is to be accorded the widest scope consistent with the principles and novel features disclosed herein.

1. A. system for distributed worker-sourced process engineering, the system comprising:
a process portion input module to allow a worker to directly provide process statements to the system that indicate a local process portion that the worker performs;
a statement verification module to dynamically verify the process statements of the worker as the worker provides them to aid the worker in entering the process statements; and
a process assembler module to:
automatically assemble an overall or global process or process portion based on the process statements of the worker and process statements of other workers, and
provide the overall or global process or process portion to an analyst for review.

2. The system of claim 1, wherein the dynamic verification is based on at least one of proper syntax of the process statements and consistency between the process statements and process statement of other workers.

3. The system of claim 1, wherein, to provide the process statements, the process portion input module is further to allow the worker to select from a set of defined process statement templates and configure the selected process statement templates.

4. The system of claim 3, wherein the aid for the worker to enter the process statements includes suggestions regarding proper configuration of the process statement templates.

5. The system of claim 3, wherein the process statement templates in the set of defined process statement templates are of a human-friendly, textual language.

8. The system of claim 5, further comprising a translation module to translate the overall or global process or process portion from the human-friendly, textual language to a process modeling standard.

7. A method executed by a system for distributed worker-sourced process engineering comprising:
allowing a worker to provide process statements to the system that indicate a local process portion that the worker performs, wherein the process statements are in a human-friendly, textual language that is based on a business process standard and a natural language;
concurrently with the worker providing the process statements, verifying the process statements and providing suggestions to the worker to aid the worker in entering the process statements, wherein the verifying includes comparing the process statements to process statements provided by other workers to determine inconsistencies;
automatically assembling an overall or global process or process portion based on the process statements of the worker and process statements of other workers; and
providing the overall of global process or process portion to an analyst for review.

8. The method of claim 7, further comprising providing a set of defined process statement templates, each being configurable to create a process statement, wherein allowing the worker to provide process statements includes, for each process statement, allowing the worker to select a process statement template from the from the set and allowing the worker to configure the selected process statement template.

9. The method of claim 8, wherein each process statement template of the set includes at least one argument, and wherein each process statement template is configurable by allowing a worker to provide a value for each argument of the process statement template.

10. The method of claim 9, wherein providing suggestions to the worker to aid the worker in entering the process statements includes, for at least one of the process statements, providing value options for at least one argument of the at least one process statements.

11. The method of claim 7, further comprising providing a process statement viewer allows the worker to view the worker's verified process statements and verified process statements of other workers as they fit within the overall or global process or process portion.

12. The method of claim 8, further comprising allowing the worker to perform at least one of the following:
enter comments related to a process statement template of the set of defined process statement templates or a particular process statement of the worker or other workers, and
view comments from other workers related to a process statement template of the set of defined process statement templates or a particular process statement of the worker or other workers.

13. The method of claim 12, wherein each comment entered and/or viewed by the workers or by the other workers is at least one of the following: a textual comment; an email message; an audio message; an audio conversation between multiple workers; a video message; and a video conversation between multiple workers.

14. A machine-readable storage medium encoded with instructions executable by at least one processor of a system for distributed worker-sourced process engineering, the machine-readable storage medium comprising:
instructions to allow a worker to directly provide process statements to the system that indicate a local process portion that the worker performs;
instructions to dynamically verify the process statements of the worker as the worker provides them to aid the worker in entering the process statements, wherein the dynamic verification is based on checks for consistency between the process statements and process statement of other workers;
instructions to automatically assemble an overall or global process or process portion based on the process statements of the worker and process statements of other workers; and
instructions to provide the overall or global process or process portion to an analyst for review.

15. The machine-readable storage medium of claim 14, wherein the checks for consistency include at least one check to determine whether an input of a process statement of the worker is defined in a different process statement of the worker or a process statement of another worker.

16. The machine-readable storage medium of claim 14, wherein the instructions to allow the worker to directly provide process statements are tether to allow the worker to select from a set of defined process statement templates and configure the selected process statement templates.

17. The machine-readable storage medium of claim 14, further comprising instructions to allow the worker enter comments about an inconsistency between a process statement of the worker and a process statement of another worker.

18. A machine-readable storage medium of claim 17, wherein the overall or global process or process portion provided to analyst includes the comments.
